(19) United States
(12) Patent Application Publication
(10) Pub. No.: US 2007/0280331 A1
(43) Pub. Date: Dec. 6, 2007

(54) Temperature-sensitive film

(76) Inventor: Ping-Kun Lin, Changhua County (TW)

Correspondence Address: PING-KUN LIN, 235 Chung - Ho Box 8-24, Taipei, omitted

(21) Appl. No.: 11/443,420

(22) Filed: May 31, 2006

(51) Int. Cl. G01K 11/00

(52) U.S. Cl. 374/162

(57) ABSTRACT

A temperature-sensitive film comprises a transparent film and a layer of dark-colored coating, attached on the inner surface of the transparent film, that will change to be of lighter color when heated, whereby the predetermined decorative pattern on the outer surface of the material where the temperature-sensitive film is applied to will be underscored. The dark-colored temperature-sensitive film is attached onto the surface of the material for hiding the decorative pattern thereon. The film will then turned light or transparent when it is heated, therefore disclosing the surface pattern thereunder.

### FIELD OF THE INVENTION

The present invention relates to temperature-sensitive films covering a material, and more particularly to a temperature-sensitive film coated on one side with a layer of temperature-sensitive adhesive coating and capable of being applied to materials of various types. Thereby, the predetermined decorative pattern on the surface of the substrate material will be underscored.

### BACKGROUND OF THE INVENTION

Temperature-sensitive films of the prior art are applied on the outer surface of an item of clothing and a shoe by netted-plate printing, wherein colored temperature-sensitive paint forms the pattern of characters, trade marks or other decorative pictures. Thereby, a change in temperature due to body temperature or different surrounding temperature will change the color of the paint.

Since the above patterns are directly printed on a substrate material such as the surfaces of an item of clothing and a shoe, they are easy to wear out after repetitious cleansing, and hence the effect of color variation due to temperature will be lost.

Accordingly, a protective acrylic layer is invented for coating the surface regions of color variation formed by the conventional printing means. The patterns are still directly printed on the substrate materials, such as the surfaces of an item of clothing and a shoe, but the protective layer prevents the patterns from being washed away. However, since the temperature-sensitive patterns are printed on the substrate materials, whether the patterns can be stably attached thereon depends on the properties of the substrate materials. Sometimes the composition of the temperature-sensitive paint should be varied to accommodate the substrate materials, making the production process more complicated and costly.

### SUMMARY OF THE INVENTION

Accordingly, the primary objective of the present invention is to provide a temperature-sensitive film capable of overcoming the above-mentioned disadvantage. The temperature-sensitive film can be attached to a substrate material easily. A layer of temperature-sensitive coating is painted on the inner surface of the transparent plastic film before it is covered over the substrate material with a predetermined surface pattern. The surface decorative pattern on the substrate material will be underscored when the dark-colored temperature-sensitive coating over it is heated and turn light or transparent. Therefore, the problem of complicated and costly production process is solved.

The various objects and advantages of the present invention will be more readily understood from the following detailed description when read in conjunction with the appended drawings.

### BRIEF DESCRIPTION OF THE DRAWINGS

FIG. 1 is a perspective view of a substrate material coated with temperature-sensitive film of the present invention.

FIG. 2 is a lateral cross-sectional view of the substrate material coated with temperature-sensitive film in FIG. 1.

FIG. 2A is a local view of a substrate material coated with temperature-sensitive film wherein the temperature-sensitive film is attached on the substrate material by sewing.

FIG. 2B is a local view of a substrate material coated with temperature-sensitive film wherein the temperature-sensitive film is attached on the substrate material by high-frequency waves.

FIG. 2C is a local view of a substrate material coated with temperature-sensitive film wherein the temperature-sensitive film is attached on the substrate material by an adhesive means.

FIG. 3 shows a temperature-sensitive film of the present invention coated on a bag.

FIG. 4 shows a temperature-sensitive film of the present invention coated on an item of clothing.

FIG. 5 shows a temperature-sensitive film of the present invention coated on a shoe.

### DETAILED DESCRIPTION OF THE PREFERRED EMBODIMENTS

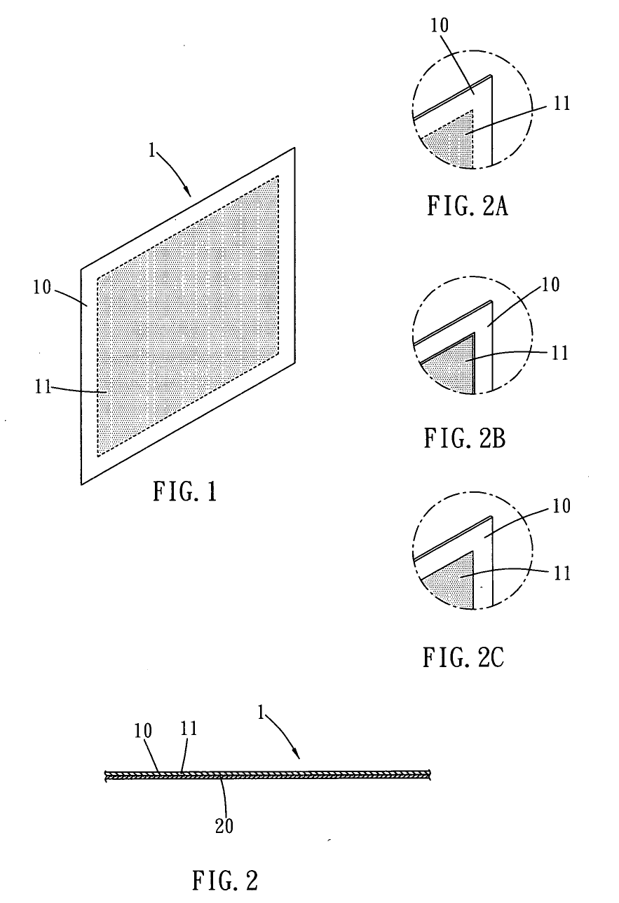

Referring to FIGS. 1 and 2, a transparent plastic film 10 attached on a substrate material coated with temperature-sensitive film 1 is made of recycled TPU (or PET, PU and silica gel) with a thickness between 0.08 to 3 mm. The transparent plastic film 10 is coated on a substrate material 20 by a means of attachment that may varied according to the type of the substrate material 20. If the substrate material 20 is a piece of cloth or leather, the attachment is by sewing or by an adhesive means, as shown in FIGS. 2A and 2C. If the substrate material 20 is a piece of plastic, the attachment is by high-frequency waves, as shown in FIG. 2B. The inner surface of the transparent plastic film 10 facing the substrate material 20 are applied with dark-colored temperature-sensitive coating 11.

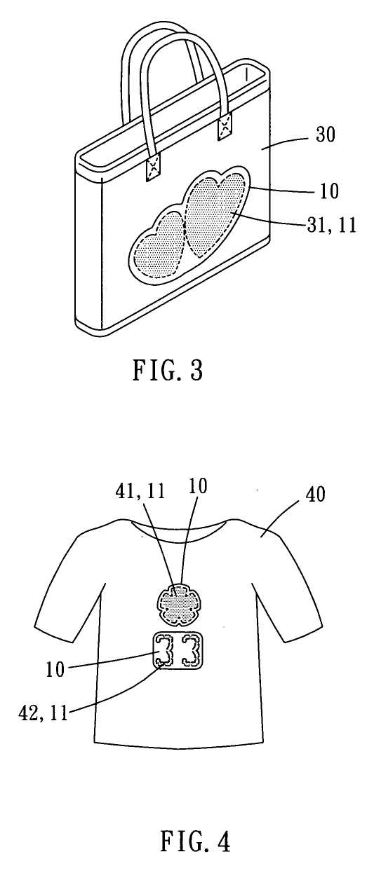

Referring to FIG. 3, when the transparent plastic film 10 is attached on a surface of a leather bag 30, the temperature-sensitive coating 11 that is dark-colored at room temperature covers a heart-shaped surface decorative pattern 31. As the temperature-sensitive coating 11 is heated, the heat-sensitive color-varying agent therein will turn the temperature-sensitive coating 11 light or transparent, whereby the heart-shaped surface decorative pattern 31 can be seen. When the temperature is back to room temperature, the pattern is hidden again.

Referring to FIG. 4, when the transparent plastic film 10 is attached on a surface of an item of clothing 40, the temperature-sensitive coating 11 that is dark-colored at room temperature covers a flower pattern 41. As the temperature-sensitive coating 11 is heated, the heat-sensitive color-varying agent therein will turn the temperature-sensitive coating 11 light or transparent, whereby the flower pattern 41 can be seen. When the temperature is back to room temperature, the pattern is hidden again.

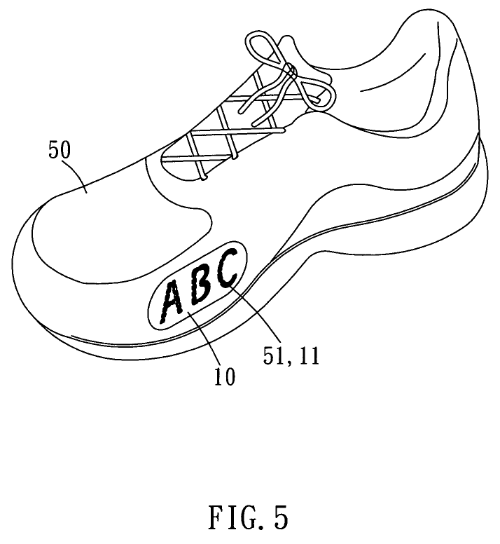

Referring to FIG. 5, when the transparent plastic film 10 is attached on a surface of a shoe 40, the temperature-sensitive coating 11 that is dark-colored at room temperature covers a character pattern 51. As the temperature-sensitive coating 11 is heated, the heat-sensitive color-varying agent therein will turn the temperature-sensitive coating 11 light or transparent, whereby the character pattern 51 can be seen. When the temperature is back to room temperature, the pattern is hidden again.

The primary advantage of the present invention is that the temperature-sensitive coating 11 is painted on the inner surface of the transparent plastic film 10 before it is applied over a substrate material 20 with a predetermined surface pattern. It is not necessary to consider the property of the substrate material 20 and the attachment of the temperature-sensitive coating 11 to the substrate material 20. The surface decorative pattern on the substrate material 20 will be underscored when the dark-colored temperature-sensitive coating 11 over it is heated and turn light or transparent. Therefore, the problem of complicated and costly production process is solved.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A temperature-sensitive film, comprising:
a transparent plastic film attachable to a substrate material; and
a layer of dark-colored temperature-sensitive coating painted on an inner surface of said transparent plastic film, whereby a surface decorative pattern on the substrate material hidden by said temperature-sensitive coating will be seen when said temperature-sensitive coating exceeds a predetermined temperature and turn light and even transparent.

2. The temperature-sensitive film of claim 1 wherein said transparent plastic film is made of a plastic material selected from TPU, PET, PU and silica gel.

3. The temperature-sensitive film of claim 1 wherein said substrate material is selected from a piece of cloth, a piece of leather and a piece of plastic.

4. The temperature-sensitive film of claim 1 wherein said transparent plastic film has a thickness between 0.08 to 3 mm.

5. The temperature-sensitive film of claim 2 wherein said transparent plastic film has a thickness between 0.08 to 3 mm.

6. The temperature-sensitive film of claim 1 wherein said transparent plastic film is attached to said substrate material by a means selected from sewing, high-frequency waves and glue-adhesion.

7. The temperature-sensitive film of claim 2 wherein said transparent plastic film is attached to said substrate material by a means selected from sewing, high-frequency waves and glue-adhesion.
